(19) United States
(12) Patent Application Publication
(10) Pub. No.: US 2010/0220786 A1
(43) Pub. Date: Sep. 2, 2010

(54) METHOD AND APPARATUS FOR MULTIPLE REFERENCE PICTURE MOTION ESTIMATION

(75) Inventors: Lu Wang, Shenzhen (CN); Xiao Zhou, Hong Kong (HK); Yan Huo, Shekou (CN)

Correspondence Address: FULBRIGHT & JAWORSKI L.L.P., 600 CONGRESS AVE., SUITE 2400, AUSTIN, TX, 78701, US

(73) Assignee: Hong Kong Applied Science and Technology Research Institute Company Limited, Shatin (HK)

(21) Appl. No.: 12/394,869

(22) Filed: Feb. 27, 2009

(51) Int. Cl. H04N 7/26

(52) U.S. Cl. 375/240.15; 375/240.16; 375/E07.104

(57) ABSTRACT

The claimed invention relates to efficient use of data for multiple reference picture motion estimation. Multiple reference picture motion estimation involves a large amount of data due to the processing of multiple reference pictures. The claimed invention discloses a method 101 and a system for implementing this method to reduce the memory size required for data storage and the bandwidth required for data loading. The claimed invention thus improves the efficiency of performing multiple reference picture motion estimation.

### RELATED APPLICATION

There are no related applications.

### TECHNICAL FIELD

The claimed invention relates generally to image/video signal processing. In particular, the claimed invention relates to motion estimation for video encoding and motion detection. In particular, the motion estimation in the claimed invention refers to multiple reference picture motion estimation. Furthermore, the claimed invention relates to efficient use of data for multiple reference picture motion estimation. The claimed invention is applicable in motion estimation algorithm with fixed search range as well as motion estimation algorithm with non-fixed search range.

### SUMMARY OF THE INVENTION

For transmission or other purposes, a digital video is encoded to reduce the video size and thus the bandwidth required. At the receiver side, the encoded digital video will be decoded to reproduce the digital video.

Motion estimation is a common technique used in various video coding. Motion estimation exploits the temporal redundancy to achieve bandwidth reduction because a video is simply a series of pictures (also known as frames), and the content of these pictures is repetitive as the pictures share similar scenes or objects. Therefore, data required for transmission can be reduced if the pattern of how they are going to repeat themselves in the subsequent pictures is known.

In order to know the pattern of how data are going to repeat themselves in the subsequent pictures, pictures need to be compared with one another to see how they match with each other. For example, in order to encode a picture, another picture which immediately precedes the picture to be encoded is used for comparison. In order to enhance the accuracy of the comparison result, more than one picture which are neighbors to the picture to be encoded are used, for example, an object in a picture may fail to appear in the immediate subsequent picture and cannot be matched because it may be blocked by a moving car; however, it will appear in the following pictures for matching to be done after the moving car has gone. These pictures which are used for comparing with the picture to be encoded are known as reference pictures, therefore, motion estimation which makes use of multiple reference pictures is generally known as multiple reference picture motion estimation. The picture to be encoded is generally known as current picture.

To process those pictures, a huge computation power or memory size is required if the processing is done in a picture-by-picture manner. Therefore, pictures are further divided into smaller units known as blocks (macroblock is one kind of blocks) for processing. A picture block is a block in a picture, and the terms “picture block” and “block” are used interchangeably hereinafter.

For motion estimation involving multiple reference pictures, multiple reference blocks of multiple reference pictures are required to be loaded into the internal memory, for example, cache, from an external memory, for example, RAM (random access memory), in order to process a current picture. However, a problem arises; firstly, the loading of data from external memory to internal memory takes time. Therefore, it is time-consuming if each block in a current picture needs to wait for multiple reference blocks of multiple reference pictures to be loaded before performing multiple reference picture motion estimation. Secondly, the storage of multiple reference blocks of multiple reference pictures for each block in a current picture requires a large internal memory.

Therefore, instead of having to wait for loading multiple reference blocks of multiple reference pictures into internal memory, the claimed invention provides a solution to save time and to reduce the size requirement of the internal memory.

In order to achieve such efficiency improvement, the claimed invention adopts three approaches as follows; firstly, at each time instance, one or more current pictures are compared with a single reference picture concurrently. That means multiple current pictures may be referenced to a single reference picture concurrently and processing such as encoding and motion estimation is performed for each of these multiple current pictures in parallel. Therefore, reference blocks of each reference picture need not be loaded into the internal memory or be present in the internal memory for multiple time instances because all current pictures which are required to reference to this reference picture have done so within a single time instance.

Secondly, instead of waiting all the multiple reference pictures to be available for processing, each current picture is processed with one reference picture at a time. Therefore, there is no need to wait for the loading of multiple blocks of multiple reference pictures and no huge memory size is required to hold all the multiple blocks of multiple reference pictures.

Thirdly, the claimed invention does not limit the reference picture type, the reference picture can be the original raw picture, the reconstructed picture, synthesis picture and so on.

In this document, the terms “frame” and “picture” are used interchangeably hereinafter to represent a picture in a video. For a multiple reference picture motion estimation, a current picture, which may be under encoding, references to one or more reference pictures. The claimed invention allows multiple current pictures which are under processing to reference to a single reference picture. The claimed invention reuses the overlapped searching region without any shift operation.

Consequently, at any time instance, not all the multiple blocks of multiple reference pictures are required to be loaded into the internal memory. The size of the internal memory of the claimed invention is reduced and the idle time before processing a current picture to wait for the internal memory to be loaded with multiple blocks of multiple reference pictures is reduced. Search window data for temporally adjacent reference blocks, i.e. the reference pictures, are thus reused. Memory bandwidth is reduced because not all multiple reference pictures are required to be loaded at a time.

The claimed invention is suitable for FPGA and DSP implementation among others.

It is an object of the claimed invention to not only consider the single reference picture motion estimation data reuse and internal memory reduction but also consider the multiple reference picture motion estimation algorithm. The claimed invention also overcomes the limitation of the parallel operation of direct memory access (DMA) and motion estimation (ME) as well as some limitations to the motion estimation precision. The claimed invention enables the parallel running of multiple reference search modules so that searches are performed for one or more current pictures simultaneously.

It is a further object of the claimed invention to simplify the control logic of reference blocks loading to support different block types (such as 16×16/16×8/8×16/8×8 and others) multiple reference picture motion estimation. The claimed invention supports multiple inter block type as well as multiple block types and only needs to run interpolation module once to encode M block types rather than running interpolation module N×M times for supporting N reference pictures and M block types (M: 0-9) so that calculation overlay problem can be overcome.

It is a further object to further decrease the bandwidth requirement by incorporating data reuse for block matching motion estimation into the claimed invention. The claimed invention fulfills low bandwidth requirements.

It is a further object of the claimed invention to enable data reuse for multiple reference picture motion estimation. The claimed invention is capable to be combined with certain single picture data reuse methods, such as Level C, Level C+, to enhance the performance.

It is a further object of the claimed invention to enhance the coding efficiency. The claimed invention decreases the algorithm control logic complexity.

It is a further object of the claimed invention to enable the claimed invention to be applicable in motion estimation algorithm with fixed search range as well as motion estimation algorithm with non-fixed search range.

It is a further object of the claimed invention to decrease the bus bandwidth and internal memory requirement.

It is a further object of the clamed invention to decrease the algorithm control logic complexity.

Other aspects of the claimed invention are also disclosed.

### BRIEF DESCRIPTION OF THE DRAWINGS

These and other objects, aspects and embodiments of this claimed invention will be described hereinafter in more details with reference to the following drawings, in which:

FIG. 1 shows a flow diagram of the processing for multiple reference picture motion estimation.

FIG. 2 shows the content in internal memory and external memory at different time instances during coding for an embodiment where 5 reference pictures are used.

FIG. 3 shows a block diagram of an embodiment of motion estimation process using double buffer.

FIG. 4 shows an implementation example for five reference frames without B frame, having a coding pattern of IPPPPP.

FIG. 5 shows an implementation example for two reference frames with one B frame (no hierarchic-B frame).

FIG. 6 shows an implementation example for two reference frames with one B frame (no hierarchic-B frame), having a coding pattern of IBPBPBPBP, with parallel operations.

FIG. 7 shows an implementation example for two reference frames with two B frames (no hierarchic-B frame), having a coding pattern of IBBPBBPBBPBBP.

FIG. 8 shows an implementation example for two reference frames with three B frames (with hierarchic-B frame), having a coding pattern of IBbBPBbBPBbBPBbBP.

### DETAILED DESCRIPTION OF THE INVENTION

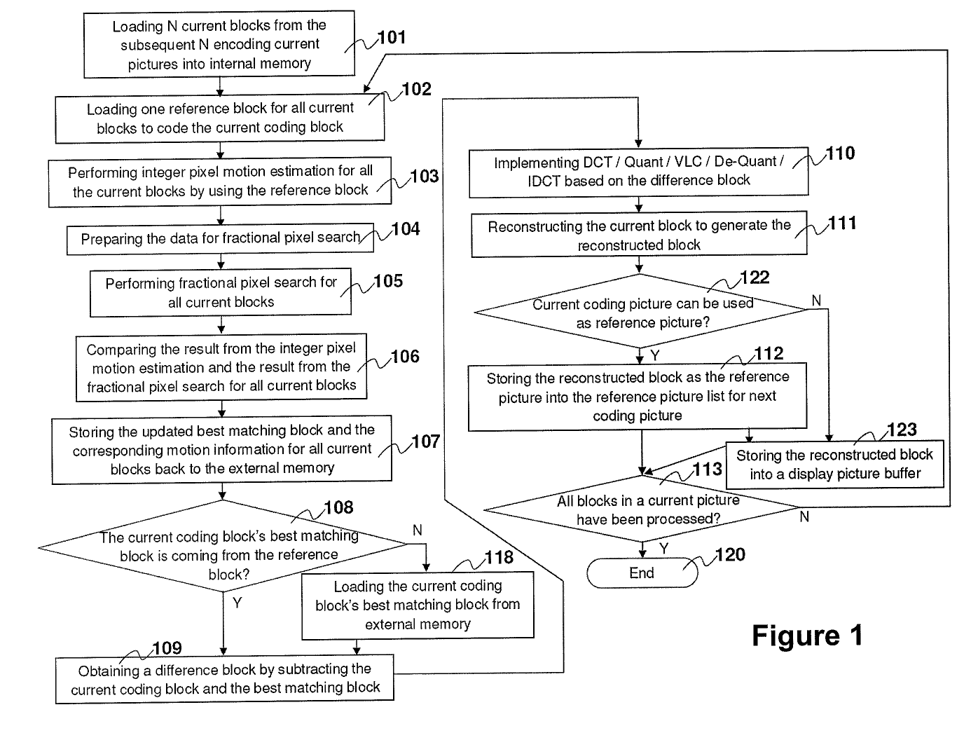

FIG. 1 shows a flow diagram of the processing for multiple reference picture motion estimation. Multiple current pictures are referenced to one single reference picture. There are N current pictures to make up the multiple current pictures. The parameter n is equal to the reference picture number. Current blocks with the same pixel position from different current pictures are loaded. If current blocks' predict motion vectors point to different position, then a decision module is used to decide how large a reference block need to be loaded into an internal memory.

In an embodiment, the following assumptions are made, and the data/parameters in use are for illustrative purposes whereas the method as illustrated is capable to be easily adapted to any other data/parameters:

1. The encoder supports N reference pictures, n changes from 0 to N−1.

2. The size of motion information (sizeof (blk_info)) is equal to 64 bytes: sizeof (blk_info)=64;

3. Block width (blk_width) is equal to 16: blk_width=16;

4. Block height (blk_height) is equal to 16 : blk_height=16;

5. Search range (SR) is from −127 to 128, i.e., [−127, 128]: SR=128;

6. Reference block width equal to ((SR<<1)+blk_width);

7. Picture_width is the horizontal size of the picture;

8. Picture_height is the vertical size of the picture;

9. Frame_rate is the frame rate per second of the input video sequence.

Furthermore, the following are defined for external memory organization:

1. Original video sequences, which include current encoding picture, is curr_pic[n] whereas 0≦n<N.

curr_pic[0] (the 1^{st} picture to be encoded, also representing the one
currently being encoded);
curr_pic[1] (the 2^{nd} picture to be encoded);
......
curr_pic[N−1] (the N^{th} picture to be encoded).

2. Reference picture is one of the previous reonstructed pictures: ref_pic.

ref_pic is curr_pic[0]’s 1^{st} reference picture;
ref_pic is curr_pic[1]’s 2^{nd} reference picture;
.......
ref_pic is curr_pic[N−1]’s Nth reference picture.

3. Predict pictures are pred_pic[n] whereas 0≦n<N.
Predict picture is formed by the predict blocks, which are saved to the external memory by motion estimation engine block by block.

pred_pic[0] is curr_pic[0]’s predict picture;
pred_pic[1] is curr_pic[1]’s predict picture;
......
pred_pic[N−1] is curr_pic[N−1]’s predict picture.

4. Best Information pictures are info_pic[n] whereas 0≦n<N.
Best information picture is formed by the best info blocks, which are saved to the external memory by motion estimation engine block by block.

info_pic[0] is curr_pic[0]’s best information pictures;
info_pic[1] is curr_pic[1]’s best information pictures;
......
info_pic[N−1] is curr_pic[N−1]’s best information pictures.

In addition to the external data organization, the following are defined for internal data organization:

1. Memory for current block of curr_pic[n] is curr_blk[n] whereas 0≦n<N;

2. Memory for reference block of ref_pic is ref_blk;

3. Memory for Motion information of curr_blk[n] is blk_info[n] whereas 0≦n<N;

4. Memory for Predict block data of curr_blk[n] is pred_blk[n] whereas 0≦n<N;

5. Reconstructed block data of curr_pic[0] is recon_blk whereas 0≦n<N;

6. 1 set of Half (½) pixel arrays and 1 set of quarter (¼) pixel arrays for ref_blk. Different fractional search algorithms lead to different fractional array sizes;

7. Neighbor blocks' motion information is neigh_info;
a. Left blocks motion information is left_info;
b. Up row blocks motion information is up_info[block_col];
Different motion estimation algorithms need different neigh_info sizes.

According to the above definitions, the encoding flow is defined as follows:

Step 1: In a current picture loading step 101, start with a new current picture (curr_pic[0]) in which the encoder are initialized. Correspondingly, the picture coding type and other related header information are determined before proceeding to the block encoding process.

Step 2: Begin the block encoding process. For example, the encoder supports N reference frames. N current blocks are loaded from the subsequent N encoding current pictures to the internal memory. The N current blocks (curr_blk[n]) are loaded from the original video sequence in external memory to internal memory in the following way:

Load 1st curr_blk[0] from curr_pic[0];
Load 2nd curr_blk[1] from curr_pic[1];
......
Load Nth curr_blk[N−1] from curr_pic[N−1];

As a result, the internal memory size for curr_blk[n] is:

N×16×16=256N bytes
If N is equal to 5, then the internal memory size is:

256×5=1280 bytes
The bandwidth for data loading is Picture_width×Picture_height×frame_rate×N (bytes/second).

Step 3: In a reference block loading step 102, load one reference block (ref_blk) for all current block (curr_blk[n]) from a reference picture (ref_pic) in external memory to internal memory according to the search range.

Load blk_info[n] for all curr_blk[n] from external memory to internal
memory;
Load ref_blk from ref_pic;
Load blk_info[0] from pic_info[0] in external memory;
Load blk_info[1] from pic_info[1] in external memory;
......
Load blk_info[N−1] from pic_info[N−1] in external memory;

As a result, the internal memory for reference data is:

(SR×2+blk_width)×(SR×2+blk_height)=(128×2+16)×(128×2+16)=73,984 bytes
The bandwidth for reference data loading is:

(SR×2+blk_width)×(SR×2+blk_height)×total_block_number×frame_rate=(128×2+16)×(128×2+16)×total_block_number×frame_rate=73,984×total_block_number×frame-rate (bytes/second)
Whereas: total_block_number=Picture_width×Picture_Height/(blk_width×blk_height)
The internal memory size for block motion information is:

sizeof(blk-info)×N=64N bytes.
If N equal to 5, then the internal memory size is:

64×5=320 bytes
Total internal memory for reference data and motion information is:

73,984+320=74,304 bytes
The bandwidth for block motion information loading is:

sizeof(blk_info)×N×total_block_number×frame_rate=64×N×total_block_number×frame_rate bytes/second
Whereas: total_block_number=Picture_width×Picture_Height/(blk_width×blk-height)

Step 4: In an integer pixel motion estimation step 103, perform integer pixel motion estimation for all the current blocks (curr_blk[n]) by using the reference block (ref_blk). Find the best integer motion information blk_info[n], such as motion vectors, and the best integer matching blocks (pred_blk[n]) in the reference block (ref_blk) of the reference picture (ref_pic) for all the current blocks (curr_blk[n]). Each encoder can decide which motion estimation algorithm to be used. In general, motion estimation algorithms can be classified into three types:

1. Fixed search center and fixed search range. This type of motion estimation algorithms are hardware friendly, most of the hardware design use this kind of motion estimation implementation.

2. Non-fixed search center but with fixed search range which is not good for hardware implementation.

3. Non-fixed search center and non-fixed search range which is bad for hardware implementation.

Integer ME process flow:

Search ref_blk for curr_blk[0];
Search ref_blk for curr_blk[1];
......
Search ref_blk for curr_blk[N−1];
Find N best motion information blk_info[n] and N integer predict data
pred_blk[n] from ref_blk for all the curr_blk[n].

Step 5: In an interpolation step 104, prepare the data for fractional search. Interpolate the half and quarter pixel arrays for the reference block (ref_blk).

Interpolate the horizontal, vertical and cross half pixel arrays for ref_blk;

Interpolate the horizontal, vertical and cross quarter pixel arrays for the reference block (ref_blk).

Step 6: In a fractional pixel search step 105, do fractional pixel search for all current blocks curr_blk[n] by using the half pixel and quarter pixel reference arrays, and get all the best matching block (pred_blk[n]), i.e. predict block in a predict picture and the motion information (blk_info[n]) corresponding to the best matching block (pre_blk[n]) after the fractional search has been finished.

In a comparing step 106, compare the results with the motion information which are obtained from Step 3 for all the current blocks (curr_blk[n]) and update the best results to the motion information (blk_info[n]) and the best matching block (pred_blk[n]).

Step 7: In a best result updating step 107, store the updated best matching block (pred_blk[n]) and the corresponding motion information (blk_info[n]) for all the current blocks (curr_blk[n]) back to the external memory if necessary. If the best matching block (pred_blk[n]) and the corresponding motion information (blk_info[n]) have not been updated, they do not need to be stored back to external memory again.

So the maximum bandwidth for pred_blk[n] and blk_info[n] which are stored back to the external memory is:

N×(sizeof(blk_info)+(blk_width×blk_height))×total_block_number×frame_rate=N×(64+16×16)×total_block_number×frame_rate=320N×total_block_number×frame_rate bytes/sonds
If N equal to 5, then the bandwidth is:

320×5×total_block_number×frame_rate=1600×total_block_number×frame-rate bytes/second
Whereas: total_block_number=Picture_width×Picture_Height/(blk_width×blk_height)

Step 8: In a reference block checking step 108, if the current coding block's (curr_blk[0]) best matching block (pred_blk[0]) is not coming from the reference block (ref_blk), the encoder needs to load the best matching block (pred_blk[0]) from external memory in a best matching block loading step 118. Otherwise, do nothing.
So the maximum bandwidth for pred_blk[0] loading from external memory is:

blk_width×blk_height×total_block_number×frame_rate=16×16×total_block_number×frame_rate=256×total_block_number×frame_rate (bytes/second)
Whereas: total_block_number=Picture_width×Picture_Height/(blk_width×blk_height)

Step 9: In a difference block generating step 109, obtain a difference block by subtracting the current coding block (curr_blk[0]) and the best matching block (pred_blk[0]).

Step 10: In a processing step 110, implement DCT/Quant/VLC/De-Quant/IDCT based on the Difference block obtained from the difference block generating step 109.

Step 11: In a reconstructing step 111, reconstruct the current block to generate the reconstructed block (recon_blk).

Step 12: Reconstructed block (recon_blk), store the reconstructed block (recon_blk) back to the external memory, if the current picture (curr_pic[0]) can be used as reference picture according to a reference picture checking step 122, the reconstructed block (recon_blk) will be saved as the reference picture (ref_pic) into the reference picture list for next coming encoding picture, otherwise only store it to display picture buffer in a reconstructed block storing step 123.
The bandwidth for storing recon_blk to external memory is:

blk_width×blk_height×total_block_number×frame_rate=(16×16)×total_block_number×frame_rate=256×total_block_number×frame_rate bytes/second
Whereas: total_block_number=Picture_width×Picture_Height/(blk_width×blk_height)

Step 13: In a next block looping step 113, if all the blocks in the current picture (curr_pic[0]) has been processed, go to Step 1 and begin to process the next encoding picture until all the pictures have been processed, then exit in a ending step 120. Otherwise, go to Step 1 and continue to process the next block in the current picture (curr_pic[0]).

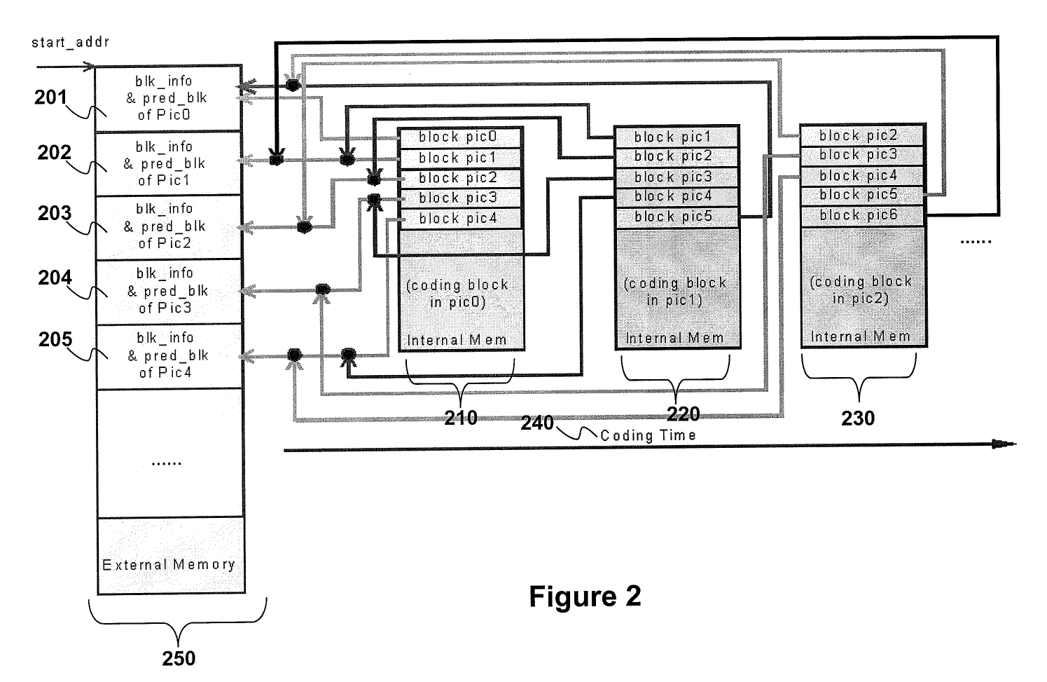

FIG. 2 shows the content in internal memory and external memory at different time instances during coding for an embodiment where 5 reference pictures are used. Along the coding timeline 240, internal memory at a first time instance 210 contains the coding all blocks in a current picture curr_pic[0] one by one. All the coding blocks are currently being encoded. The internal memory at a first time instance 210 also contains blocks from current pictures curr_pic[1], curr_pic[2], curr_pic[3] and curr_pic[4]. The internal memory at a second time instance 220 contains the coding all blocks in a current picture curr_pic[1], as well as blocks from current pictures curr_pic[2], curr_pic[3], curr_pic[4] and curr_pic[5]. The internal memory at a third time instance 230 contains the coding all blocks in a current picture curr_pic[2], as well as blocks from current pictures curr_pic[3], curr_pic[4], curr_pic[5] and curr_pic[6]. At any time instances, an external memory is used to store the best motion information (blk_info and the predict block (pred_blk) for a current picture. Assuming there are five reference pictures, the start address of the “blk_info & pred_blk” stored in the SDRAM is calculated as follows:

Addr_pic(n+0)=Start_Addr+sizeof(pic_info)×(n % 5)

Addr_pic(n+1)=Start_Addr+sizeof(pic_info)×(n % 5+1)

Addr_pic(n+2)=Start_Addr+sizeof(pic_info)×(n % 5+2)

Addr_pic(n+3)=Start_Addr+sizeof(pic_info)×(n % 5+3)

Addr_pic(n+4)=Start_Addr+sizeof(pic_info)×(n % 5+4)
Whereas, Start_Addr is the start address of the “pic_info” stored in the SDRAM
pic_info is “blk_info” & “pred_blk” of all the blocks in one picture.

The best motion information (blk_info) and the predict block (pred_blk) for all blocks of the current picture curr_pic[0] are computed from the block from the current picture curr_pic[0] in the internal memory at the first time instance 210. Then the best motion information (blk_info) and the predict block (pred_blk) for the current picture curr_pic[0] is stored in the first address location 201 in the external memory. Starting from the second time instance, the first address location 201 in the external memory will be used to store the best motion information (blk_info) and the predict block (pred_blk) for the current picture curr_pic[5] which are to be computed by the block from the current picture curr_pic[5] in the internal memory at the second time instance 220, the block from the current picture curr_pic[5] in the internal memory at the third time instance 230, the block from the current picture curr_pic[5] in the internal memory at the fourth time instance (not shown), the block from the current picture curr_pic[5] in the internal memory at the fifth time instance (not shown) and the block from the current picture curr_pic[5] in the internal memory at the sixth time instance (not shown).

The best motion information (blk_info) and the predict block (pred_blk) for the current picture curr_pic[1] are computed from the block from the current picture curr_pic[1] in the internal memory at the first time instance 210 and the block from the current picture curr_pic[1] in the internal memory at the second time instance 220. Then the best motion information (blk_info) and the predict block (pred_blk) for the current picture curr_pic[1] is stored in the second address location 202 in the external memory. Starting from the third time instance, the second address location 202 in the external memory will be used to store the best motion information (blk_info) and the predict block (pred_blk) for the current picture curr_pic[6] which are to be computed by the block from the current picture curr_pic[6] in the internal memory at the third time instance 230 and the 4 other processes for the current picture curr_pic[6] blocks in the internal memory at the subsequent 4 time instances (not shown). The best motion information (blk_info) and the predict block (pred_blk) for the current picture curr_pic[2] are computed from the block from the current picture curr_pic[2] in the internal memory at the first time instance 210, the block from the current picture curr_pic[2] in the internal memory at the second time instance 220 and the block from the current picture curr_pic[2] in the internal memory at the third time instance 230. Then the best motion information (blk_info) and the predict block (pred_blk) for the current picture curr_pic[2] is stored in the third address location 203 in the external memory.

The best motion information (blk_info) and the predict block (pred_blk) for the current picture curr_pic[3] are computed from the block from the current picture curr_pic[3] in the internal memory at the first time instance 210, the block from the current picture curr_pic[3] in the internal memory at the second time instance 220, the block from the current picture curr_pic[3] in the internal memory at the third time instance 230 and the block from the current picture curr_pic[3] in the internal memory at the fourth time instance (not shown). Then the best motion information (blk_info) and the predict block (pred_blk) for the current picture curr_pic[3] is stored in the fourth address location 204 in the external memory.

The best motion information (blk_info) and the predict block (pred_blk) for the current picture curr_pic[4] are computed from the block from the current picture curr_pic[4] in the internal memory at the first time instance 210, the block from the current picture curr_pic[4] in the internal memory at the second time instance 220, the block from the current picture curr_pic[4] in the internal memory at the third time instance 230, the other two processes for the current picture curr_pic[4] blocks in the internal memory at the subsequently two time instances (not shown). Then the best motion information (blk_info) and the predict block (pred_blk) for the current picture curr_pic[4] is stored in the fifth address location 205 in the external memory.

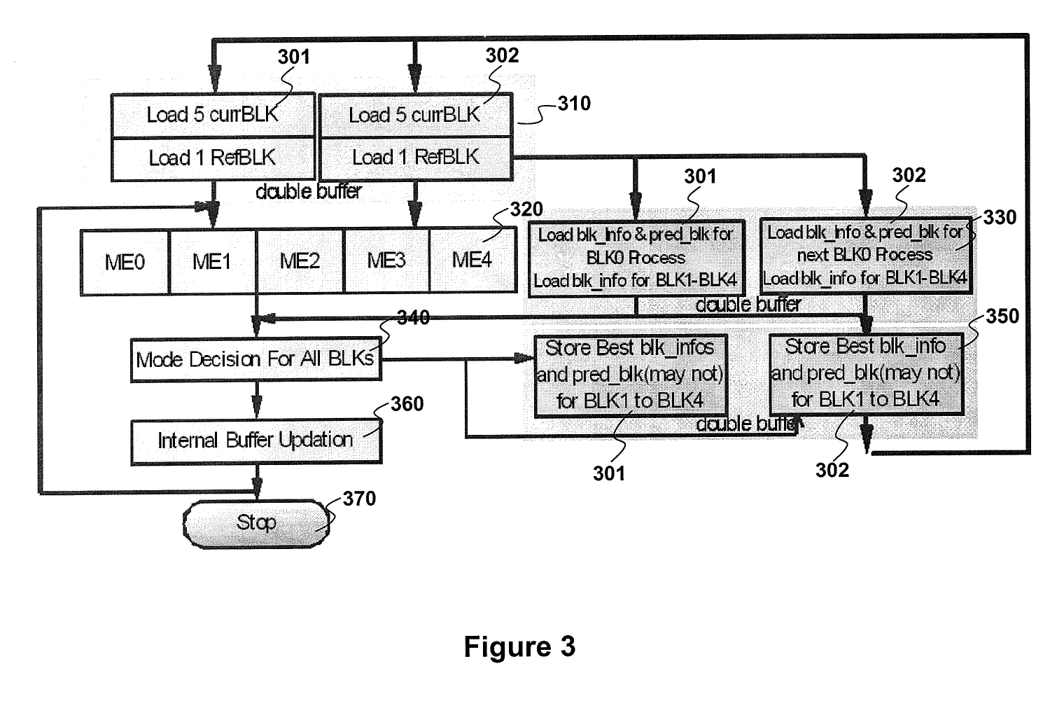

FIG. 3 shows a block diagram of an embodiment of motion estimation process using double buffer. A double buffer contains a first buffer 301 and a second buffer 302. Five current blocks and a reference block are loaded into the first buffer 301. Using the content in the first buffer 301, five motion estimation operations ME0, ME1, ME2, ME3 and ME4 are performed in a motion estimation step 320. At the same time another five current blocks and a reference block are loaded into the second buffer 302 in parallel with the ME process. In other words, one buffer is loaded with five current blocks and one reference block in a first step 310, one buffer is used by ME process in motion estimation step 320. In the meantime, the best motion information (blk_info) and the predict block (pred_blk) for the coding process of block BLK0 and the best motion information for four blocks BLK1, BLK2, BLK3 and BLK4 in the first buffer 301 of the double buffer is used in the Mode decision step 340. The best motion information (blk_info) and the predict block (pred_blk) for the next coding process of block BLK0 and the best motion information for four blocks BLK1, BLK2, BLK3 and BLK4 are loaded into the second buffer 302 of the double buffer in the second loading step 330. In a mode decision step 340, the coding mode of whether inter mode or intra mode is used is decided for all blocks after receiving the data from the motion estimation step 320 and the second loading step 330. Subsequently, the best motion information (blk_info) and predict block (pred_blk) are updated and stored into one of the first buffer 301 and the second buffer 302 in the double buffer for blocks BLK1, BLK2, BLK3, and BLK4 in the step 350. In an internal buffer update step 360, the internal double buffers are exchanged for next operation. The whole process keeps iterated until it comes to a stop in a termination step 370 when all the blocks of all current pictures available complete the coding process.

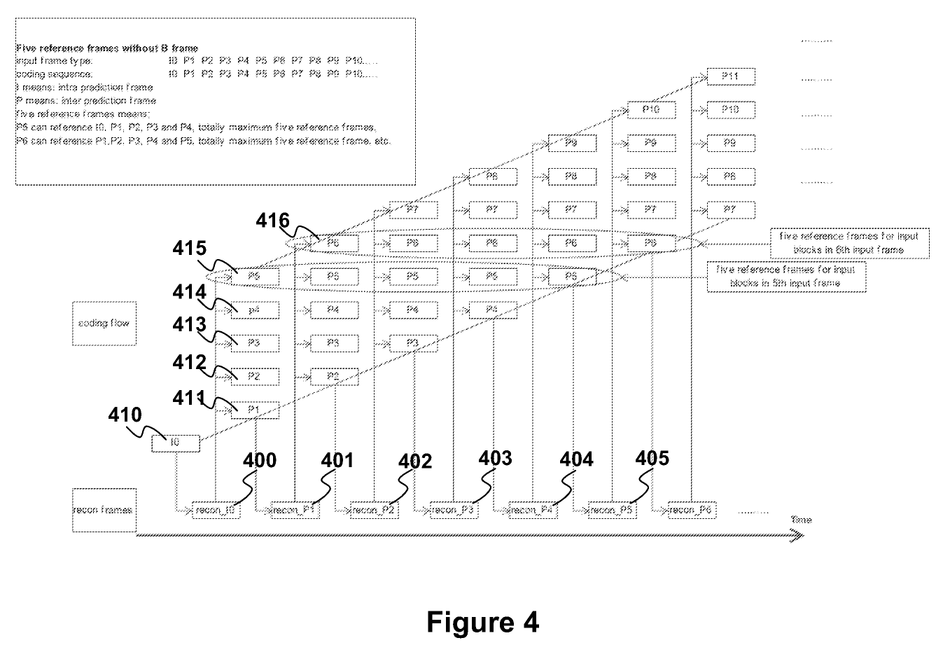

FIG. 4 shows an implementation example for five reference frames without B frame, having a coding pattern of IPPPPP. In IPPPPP coding pattern, I represents the intra prediction frame, P represents the inter prediction frame. At a first time instance, the reconstructed frame I0 (recon_I0) 400 is reconstructed from the intra prediction frame I0 410. The reconstructed frame I0 (recon_I0) 400 is used as a reference frame for input frames P1 411, P2 412, P3 413, P4 414 and P5 415. Subsequently, at a second time instance, the reconstructed frame P1 (recon_P1) 401 is reconstructed from the inter prediction frame P1 411. The reconstructed frame P1 (recon_P1) 401 is used as a reference frame for input frames P2 412, P3 413, P4 414, P5 415 and P6 416, so on and so forth. Consequently, a n^{th} reconstructed frame is used as a reference frame of the (n+1)^{th} input frame, (n+2)^{th} input frame, (n+3)^{th} input frame, (n+4)^{th} input frame and (n+5)^{th} input frame. Consequently, the 1^{st} input frame P1 411 only has one reference frame P1 (recon_P1) 401. The 2^{nd} input frame P2 412 only has two reference frames P1 (recon_P1) 401 and P2 (recon_P2) 402. The 3^{rd} input frame P3 413 only has three reference frames P1 (recon_P1) 401, P2 (recon_P2) 402 and P3 (recon_P3) 403. The 4^{th} input frame P4 414 only has four reference frames P1 (recon_P1) 401, P2 (recon_P2) 402, P3 (recon_P3) 403 and P4 (recon_P4 404. But for P5 415 and frames subsequent to P5, there are maximum five reference frames available for each frame. For example, there are five reference frames I0 (recon_I0) 400, P1 (recon_P1) 401, P2 (recon_P2) 402, P3 (recon_P3) 403, P4 (recon_P4) 404 available as input blocks in the 5^{th} input frame P5 415. There are five reference frames P1 (recon_P1) 401, P2 (recon_P2) 402, P3 (recon_P3) 403, P4 (recon_P4) 404, P5 (recon_P5) 405 available as input blocks in the 6^{th} input frame P6 416, so on and so forth. The input frames I0 410, P1 411, P2 412, P3 413 and P4 414 have less than five reference frames because there is no previous frame for these five frames. Consequently, for an nth input frame, it has reconstructed frames (n−5)^{th}, (n−4)^{th}, (n−3)^{th}, (n−2)^{th}, (n−i)^{th} as long as the reconstructed frames are available for the index number is more than or equal to zero.

In this embodiment, there are 5 reference pictures. Furthermore, half pixel interpolation and quarter pixel interpolation may also be supported. In the claimed invention, only one interpolation operation is required for each coding block during horizontal half pixel interpolation and horizontal quarter pixel interpolation. Only one interpolation operation is required for each coding block during vertical half pixel interpolation and vertical quarter pixel interpolation. Only one interpolation operation is required for each coding block during cross half pixel interpolation and cross quarter pixel interpolation. This is much more efficient than any method which requires 5 interpolation operations for each coding block during each of half and quarter pixel interpolations in horizontal, vertical and cross directions.

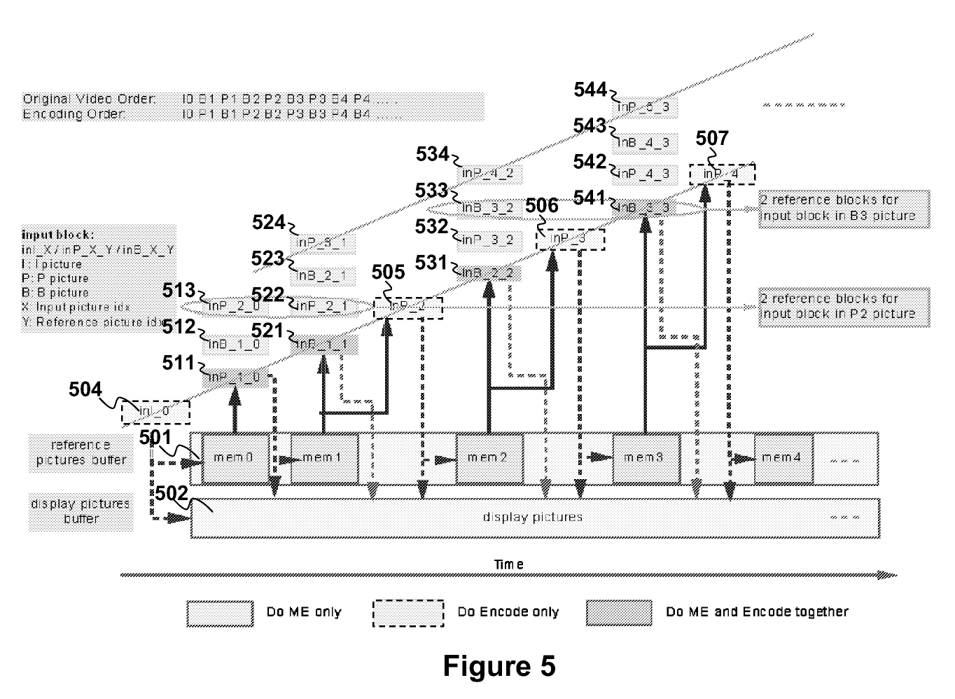

FIG. 5 shows a flowchart for the implementation of two reference frames with one B frame (no hierarchic-B frame). A reference pictures buffer 501 stores one or more reference pictures. A display pictures buffer 502 stores one or more display pictures. The input picture I0 (inI_0) 504 is encoded and reconstructed. The reconstructed picture of input picture I0 (inI_O) 504 is stored into the reference pictures buffer 501. The reconstructed picture of input picture I0 (inI_0) 504 is stored into the display pictures buffer 502. The reconstructed picture of input picture I0 in the reference pictures buffer 501 is the reference picture for the input pictures P1, B1, and P2. In other words, the reconstructed picture of the input picture I0 provides a reference block for each input block (inP_1_0) 511 from the input picture P1, a reference block for each input block (inB_1_0) 512 from the input picture P2, and a reference block for each input block (inP_2_0) 513. The input picture P1, B1 and P2 do motion estimation. The input picture P1 is encoded and reconstructed. The reconstructed picture of input picture P1 is stored into the reference pictures buffer 501 and the display pictures buffer 502. The reconstructed picture of input picture P1 in the reference pictures buffer 501 is the reference picture for the input pictures B1, P2, B2, and P3 for motion estimation. In other words, the reconstructed picture of input picture P1 provides a reference block for each input block (inB_1_1) 521 from the input picture B1, a reference block for each input block (inP_2_1) 522 from the input picture P2, a reference block for each input block (inB_2_1) 523 from the input picture B2, and a reference block for each input block (inP_3_1) 524 from the input picture P3. The input pictures B1, P2, B2, P3 do motion estimation. The input picture B1 is encoded and reconstructed. The reconstructed picture of input picture B1 is stored into the display pictures buffer 502. Using the P2's best motion information (blk_info) and predict block (pred_blk) which have already been obtained in previous step, P2 is encoded and reconstruct, The reconstructed picture of input picture P2 505 is stored into the reference pictures buffer 501 and the display pictures buffer 502. The reconstructed picture of input picture P2 (mem2) in the reference pictures buffer 501 is the reference picture for the input pictures B2, P3, B3, and P4 for motion estimation. In other words, the reconstructed picture of input picture P2 (mem2) provides a reference block for each input block (inB_2_2) 531 from the input picture B2, a reference block for each input block (inP_3_2) 532 from the input picture P3, a reference block for each input block (inB_3_2) 533 from the input picture B3, and a reference block for each input block (inP_4_2) 534 from the input picture P4. The input pictures B2, P3, B3, P4 do motion estimation. The input picture B2 is encoded and reconstructed. The reconstructed picture of input picture B2 is stored into the display pictures buffer 502. Using the P3's best motion info (blk_info) and predict block (pred_blk) which have already got in previous step, P3 is encoded. The reconstructed picture of input picture P3 506 is stored into the reference pictures buffer 501 and the display pictures buffer 502. The reconstructed picture of input picture P3 (mem3) in the reference pictures buffer 501 is the reference picture for the input pictures B3, P4, B4, and P5 for motion estimation. In other words, the reconstructed picture of input picture P3 (mem3) provides a reference block for each input block (inB_3_3) 541 from the input picture B3, a reference block for each input block (inP_4_3) 542 from the input picture P4, a reference block for each input block (inB_4_3) 543 from the input picture B4, and a reference block for each input block (inP_5_3) 544 from the input picture P5. The input pictures B3, P4, B4, P5 do motion estimation. The input picture B3 is encoded and reconstructed. The reconstructed picture of input picture B3 is stored into the display pictures buffer 502. Using the P4's best motion info (blk_info) and predict block (pred_blk) which have already got in previous step, P4 is encoded and reconstructed. The reconstructed picture of input picture P4 (mem4) 507 is stored into the reference pictures buffer 501 and the display pictures buffer 502. The pictures, i.e., frames of a video of N frames, are originally in an order of I0, B1, P1, B2, P2, B3, P3, B4, P4, . . . , B(n−1), P(n−1). The order of encoding these frames are I0, P1, B1, P2, B2, P3, B3, P4, B4, . . . , P(n−1), B(n−1). The process continues until all N input pictures are encoded, assuming there are N pictures in the video sequence to be encoded.

Therefore, in this embodiment, at some time instance, it can support partially parallel and pipeline. Such as the motion estimation process can be pipelined with the coding and reconstruct operation. Multiple motion estimation processes can be running in parallel or serial based on the hardware implementation.

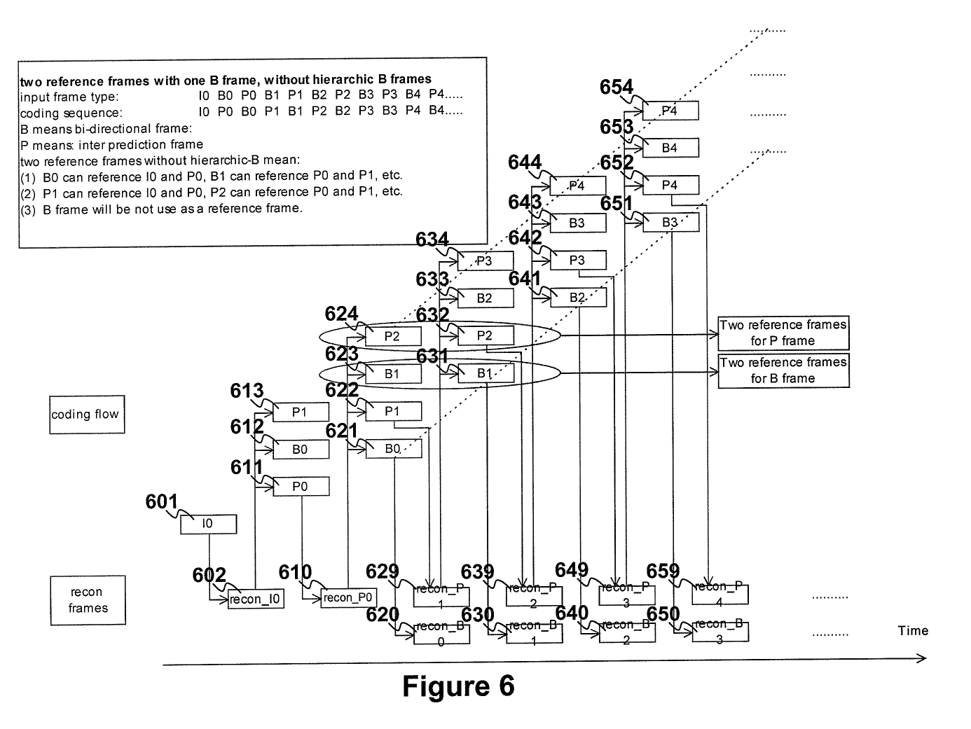

FIG. 6 shows an implementation example for two reference frames with one B frame (no hierarchic-B frame), having a coding pattern of IBPBPBPBP, with parallel operations. In the IBPBPBPBP coding pattern, I represents the Intra prediction frame, P represents the inter prediction frame, B represents bi-directional inter prediction frame and is not used as reference frame. The maximum number of reference frames is two frames. This embodiment features two reference frames with one B frame, without hierarchic B frames. Two reference frames without hierarchic B frames means the following three points: The first point is B0 can reference I0 and P0, B1 can reference P0 and P1, etc. The second point is P1 can reference I0 and P0, P2 can reference P0 and P1, etc. The third point is B frame will not be used as a reference frame.

I0 601 has no reference frame and is encoded into a reconstructed frame recon_I0 602. The reconstructed frame recon_I0 602 is used as the reference frame for P0 611, B0 612, and P1 613. The input pictures P0 611, B0 612 and P1 613 do motion estimation. P0 611 is encoded into a reconstructed frame recon_P0 610. The reconstructed frame recon_P0 610 is the reference frame for B0 621, P1 622, B1 623 and P2 624. The input pictures B0 621, P1 622, B1 623, P2 624 do motion estimation. B0 621 is encoded into a reconstructed frame recon_B0 620 and P1 622 is encoded into a reconstructed frame recon_P1 629. The reconstructed frame recon_P1 629 is the reference frame for B1 631, P2 632, B2 633 and P3 634. The input pictures B1, P2, B2, P3 do motion estimation. B1 631 is encoded into a reconstructed frame recon_B1 630 and P2 632 is encoded into a reconstructed frame recon_P2 639. recon_P2 639 is the reference frame for B2 641, P3 642, B3 643 and P4 644. The input pictures B2 641, P3 642, B3 643, P4 644 do motion estimation, B2 641 is encoded into a reconstructed frame recon B2 640 and P3 642 is encoded into a reconstructed frame recon_P3 649. The reconstructed frame recon_P3 649 is the reference frame for B3 651, P4 652, B4 653 and P5 654. The input pictures B3 651, P4 652, B4 653 and P5 654 do motion estimation B3 651 is encoded into a reconstructed frame recon_B3 650 and P4 652 is encoded into a reconstructed frame recon_P4 659, so on and so forth. The process continues until all N input frames are encoded, assuming there are N frames in the video to be encoded. In this embodiment of IBPBPBPBP coding pattern, at the B frame coding and reconstruct stage, there is parallel P frame coding and reconstruct stage.

Therefore, in this embodiment, at each time instance, there are parallel and pipeline running of the following operations for different input frames: motion estimation, coding and reconstruct operation. For example, when blocks in B0 is encoded and reconstructed, motion estimation is applied to blocks in P1 in parallel, and when blocks in P1 is encoded and reconstructed, motion estimation is applied to blocks in B1 in parallel. There is no need to store the best match block of P1 back into external memory, and there is no need to reload the original P1 when it is encoded and reconstructed, the bandwidth is thus further reduced.

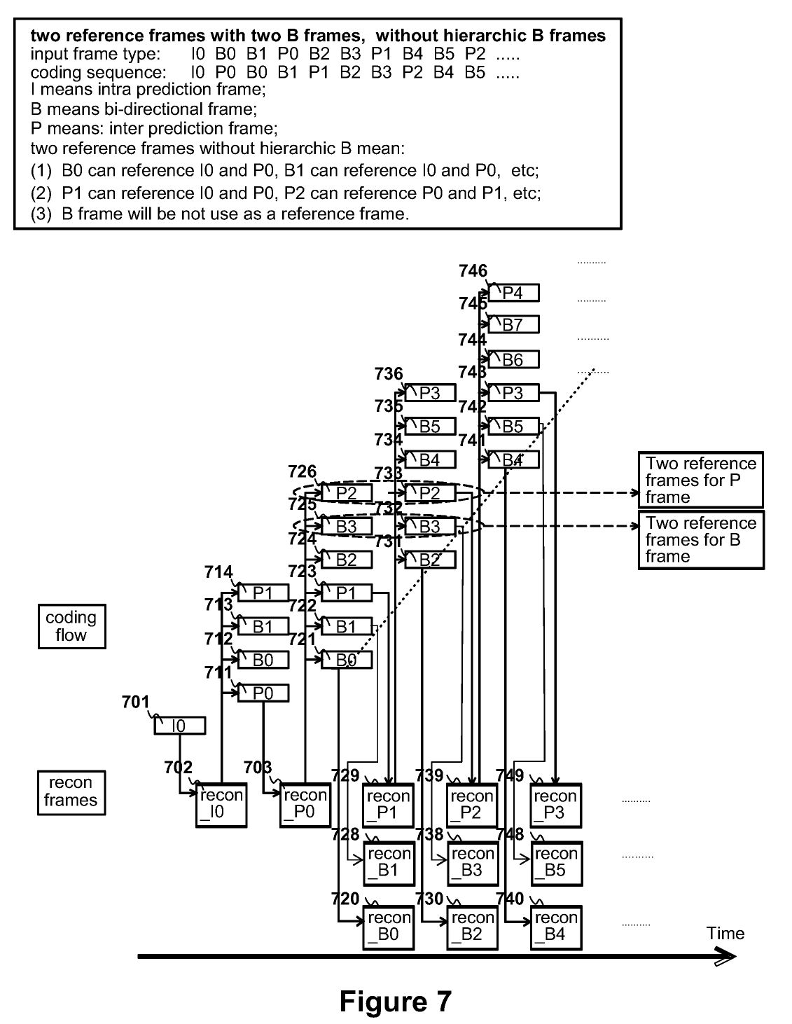

FIG. 7 shows an implementation example for two reference frames with two B frames (no hierarchic-B frame), having a coding pattern of IBBPBBPBBPBBP. In the IBBPBBPBBPBBP coding pattern, I represents the Intra prediction frame, P represents the inter prediction frame, B represents bidirectional inter prediction frame and is not used as reference frame. The maximum number of reference frame is two frames. The input frame I0 701 has no reference frame and is encoded and reconstructed into a reconstructed frame recon_I0 702. The reconstructed frame recon_I0 702 is the reference frame of the input frames P0 711, B0 712, B1 713, P1 714. The input pictures P0 711, B0 712, B1 713, P1 714 do motion estimation. The input frame P0 711 is encoded and reconstructed into a reconstructed frame recon_P0 703. The reconstructed frame recon_P0 703 is the reference frame of the input frames B0 721, B1 722, P1 723, B2 724, B3 725 and P2 726. The input pictures B0 721, B1 722, P1 723, B2 724, B3 725, P2 726 do motion estimation. The input frame B0 (712 and 721) is encoded and reconstructed into a reconstructed frame recon B0 720. The input frame B1 (713 and 722) is encoded and reconstructed into a reconstructed frame recon_B1 728. The input frame P1 (714 and 723) is encoded and reconstructed into a reconstructed frame recon_P1 729. The reconstructed frame recon_P1 729 is the reference frame of the input frames B2 731, B3 732, P2 733, B4 734, B5 735 and P3 736. The input pictures B2 731, B3 732, P2 733, B4 734, B5 735, P3 736 do motion estimation. The input frame B2 (724 and 731) is encoded and reconstructed into a reconstructed frame recon_B2 730. The input frame B3 (725 and 732) is encoded and reconstructed into a reconstructed frame recon_B3 738. The input frame P2 (726 and 733) is encoded and reconstructed into a reconstructed frame recon_P2 739. The reconstructed frame recon P2 739 is the reference frame of the input frames B4 741, B5 742, P3 743, B6 744, B7 745 and P4 746. The input pictures B4 741, B5 742, P3 743, B6 744, B7 745, and P4 746 do motion estimation. The input frame B4 (734 and 741) is encoded and reconstructed into a reconstructed frame recon B4 740. The input frame B5 (735 and 742) is encoded and reconstructed into a reconstructed frame recon_B5 748. The input frame P3 (736 and 743) is encoded and reconstructed into a reconstructed frame recon_P3 749. The process continues until all N input frames are encoded, assuming there are N frames in the video to be encoded.

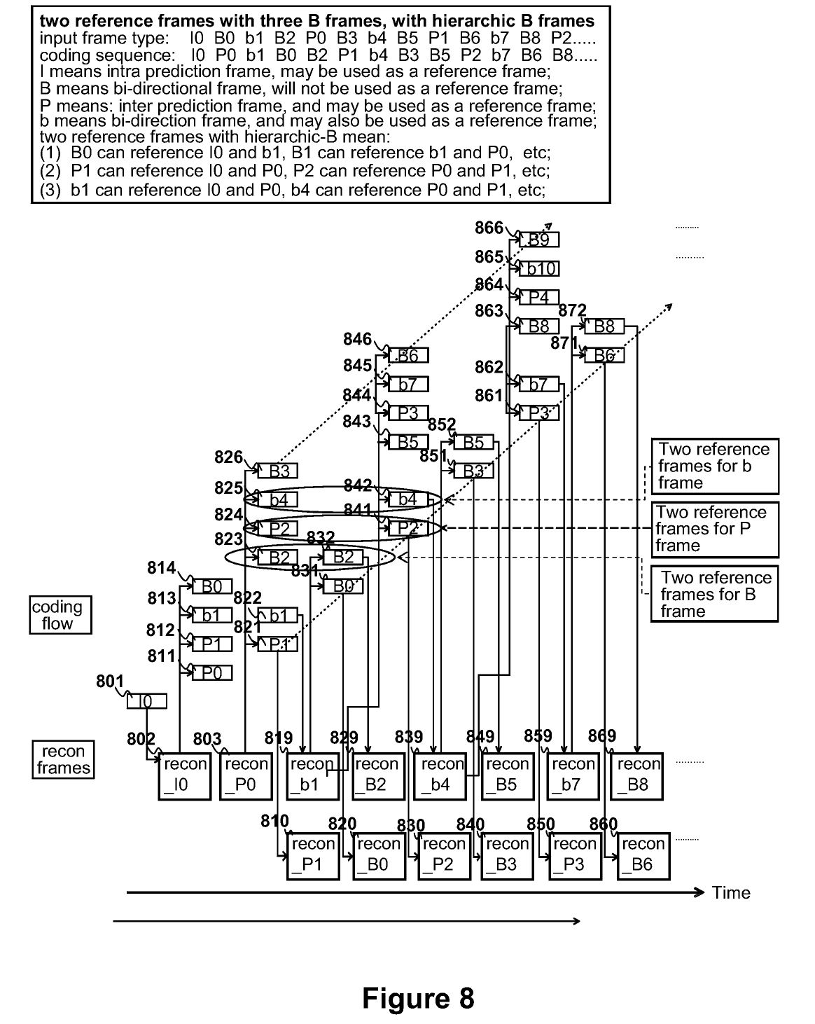

FIG. 8 shows an implementation example for two reference frames with three B frames (with hierarchic-B frame), having a coding pattern of IBbBPBbBPBbBPBbBP. In the IBbBPBbBPBbBPBbBP coding pattern, I represents the intra prediction frame and may be used as a reference frame, P represents the inter prediction frame and may be used as a reference frame, B represents bi-directional inter prediction frame and is not used as reference frame, b represents bi-directional inter prediction frame and may also be used as a reference frame. The maximum number of reference frames is two frames. The two reference frames with hierarchic-B means the following points: The first point is B0 can reference I0 and b1, B1 can reference b1 and P0, etc; The second point is P1 can reference I0 and P0, P2 can reference P0 and P1, etc; and the third point is b1 can reference I0 and P0, b4 can reference P0 and P1, etc.

For example, the input frame I0 801 has no reference frame and is encoded and reconstructed into a reconstructed frame recon_I0 802. The reconstructed frame recon_I0 802 is the reference frame of the input frames P0 811, P1 812, b1 813, and B0 814. The input frames P0 811, P1 812, b1 813, B0 814 do motion estimation. The input frame P0 811 is encoded and reconstructed into a reconstructed frame recon_P0 803. The reconstructed frame recon_P0 803 is the reference frame of the input frames P1 821, b1 822, B2 823, P2 824, b4 825 and B3 826. The input frames P1 821, b1 822, B2 823, P2 824, b4 825, B3 826 do motion estimation. The input frame P1 (812 and 821) is encoded and reconstructed into a reconstructed frame recon_P1 810. The input frame b1 (813 and 822) is encoded and reconstructed into a reconstructed frame recon_b1 819. The reconstructed frame recon_b1 819 is the reference frame of the input frames B0 831 and B2 832. The input frames B0 831, B2 832 do motion estimation. The input frame B0 (814 and 831) is encoded and reconstructed into a reconstructed frame recon_B0 820. The input frame B2 (823 and 832) is encoded and reconstructed into a reconstructed frame recon_B2 829. The reconstructed frame recon_P1 810 is the reference frame of the input frames P2 841, b4 842, B5 843, P3 844, b7 845, and B6 846. The input frames P2 841, b4 842, B5 843, P3 844, b7 845, B6 846 do motion estimation. The input frame P2 (824 and 841) is encoded and reconstructed into a reconstructed frame recon_P1 810. The input frame b4 (825 and 842) is encoded and reconstructed into a reconstructed frame recon_b4 839. The reconstructed frame recon_b4 839 is the reference frame of the input frames B3 851 and B5 852 for motion estimation. The input frames B3 851, B5 852 do motion estimation. The input frame B3 (826 and 851) is encoded and reconstructed into a reconstructed frame recon_B3 840. The input frame B5 (843 and 852) is encoded and reconstructed into a reconstructed frame recon_B5 849. The reconstructed frame recon_P2 830 is the reference frame of the input frames P3 861, b7 862, B8 863, P4 864, b10 865, and B9 866 for motion estimation. The input frames P3 861, b7 862, B8 863, P4 864, b10 865, B9 866 do motion estimation. The input frame P3 (844 and 861) is encoded and reconstructed into a reconstructed frame recon_P3 850. The input frame b7 (845 and 862) is encoded and reconstructed into a reconstructed frame recon_b7 859. The reconstructed frame recon_b7 859 is the reference fame of the input frames B6 871 and B8 872. The input frames B6 871, B8 872 do motion estimation. The input frame B6 (846 and 871) is encoded and reconstructed into a reconstructed frame recon_B6 860. The input frame B8 (863 and 872) is encoded and reconstructed into a reconstructed frame recon_B8 869. The process continues until all N input frames are encoded, assuming there are N frames in the video to be encoded.

The description of preferred embodiments of this claimed invention are not exhaustive and any update or modifications to them are obvious to those skilled in the art, and therefore reference is made to the appending claims for determining the scope of this claimed invention.

### INDUSTRIAL APPLICABILITY

The claimed invention has industrial applicability in consumer electronics, in particular with video applications. The claimed invention can be used in the video encoder, and in particular, in a multi-standard video encoder. The multi-standard video encoder implements various standards such as H.263, H.263+, H.263++, H264, MPEG-1, MPEG-2, MPEG-4, AVS (Audio Video Standard) and the like. More particularly, the claimed invention is implemented for multiple video standards encoder which supports multiple references picture motion estimation. The claimed invention can be used not only for software implementation but also for hardware implementation. For example, the claimed invention can be implemented in a DSP (digital signal processing) video encoder, Xilinx FPGA chip or SoC ASIC chip.

What is claimed is:

1. A method of motion estimation involving multiple reference pictures, comprising:
loading a plurality of current picture blocks into an internal memory from a plurality of current pictures of a video from an external memory;
providing each current picture block with a reference picture block in the internal memory from a reference picture;
applying motion estimation to each current picture block by using said reference picture block;
comparing one or more motion estimation results obtained from motion estimation using other reference picture blocks;
reconstructing one or more current picture blocks to generate one or more reconstructed picture blocks; and
assigning said one or more reconstructed picture blocks to other current picture blocks as reference picture blocks.

2. The method as claimed in claim 1, wherein:
said motion estimation is an integer motion estimation.

3. The method as claimed in claim 2, wherein:
performing fractional pixel search to compare with a result obtained from said integer motion estimation after said applying motion estimation to each current picture block.

4. The method as claimed in claim 1, wherein:
storing a best matching block and a corresponding motion information for each current picture block into said external memory after comparing one or more existing best matching blocks obtained from other reference pictures for said comparing one or more motion estimation results.

5. The method as claimed in claim 1, wherein:
said plurality of current pictures further includes one or more bi-directional frames.

6. The method as claimed in claim 6, wherein:
said one or more bi-directional frames further includes one or more hierarchic bidirectional frames.

7. The method as claimed in claim 7, wherein:
said one or more hierarchic bi-directional frames are used as one or more reference pictures for motion estimation.

8. The method as claimed in claim 1, wherein:
motion estimation of said plurality of current picture blocks is performed in parallel with reconstructing and coding of other current pictures.

9. An apparatus of motion estimation involving multiple reference pictures, comprising:
an internal memory including a first buffer and a second buffer;
said first buffer is loaded with a plurality of current picture blocks and a reference picture block; and
said second buffer is loaded with a plurality of current picture blocks and a reference picture block in parallel to performing motion estimation for a plurality of current picture blocks and a reference picture block in said first buffer.

10. The apparatus as claimed in claim 9, wherein:
said first buffer is loaded with a plurality of best motion information and a predict block.

11. The apparatus as claimed in claim 10, wherein:
said second buffer is loaded with a plurality of best motion information and a predict block.

12. The apparatus as claimed in claim 11, wherein:
mode selection is applied to all current picture blocks in both said first buffer and said second buffer.

13. The apparatus as claimed in claim 12, wherein:
said first buffer stores a plurality of best motion information and predict blocks.

14. The apparatus as claimed in claim 13, wherein:
said second buffer stores a plurality of best motion information and predict blocks.
